(19) United States
(12) Patent Application Publication
(10) Pub. No.: US 2019/0273951 A1
(43) Pub. Date: Sep. 5, 2019

(54) Determining Relevant Content for a User Locally to the User

(71) Applicant: LETSJOIN LIMITED, ILFORD (GB)

(72) Inventors: SAM GLOVER, ILFORD (GB); MORAY BARCLAY, ILFORD (GB)

(73) Assignee: LETSJOIN LIMITED, ILFORD (GB)

(21) Appl. No.: 16/336,033

(22) PCT Filed: Sep. 22, 2017
(86) PCT No.: PCT/GB2017/052844

§ 371 Date: Mar. 22, 2019

(30) Foreign Application Priority Data
Sep. 23, 2016 (GB) 1616247.1

(51) Int. Cl. H04N 21/214; H04N 21/258; H04N 21/218

(52) U.S. Cl. CPC H04N 21/2146; H04N 21/21815; H04N 21/25891; H04N 21/25841

(57) ABSTRACT

A method comprising determining (404) by a first server means local to a user device (104a) under the control of a user, if an internet connection is available enabling communication between the first server means (100) and a second server means (112) remote from the user device. Based at least on a result of the determining being that the internet connection is unavailable, the first server means then determines (414) local content items from a plurality of locally stored content items relevant to the user using locally stored contextual information associated with the user. At least one action is then performed (416) based on a result of the determining.

### FIELD OF THE INVENTION

The invention relates to a method of determining content relevant to a user locally to the user. The invention also relates to apparatus and a computer program for determining content relevant to a user locally to the user.

### BACKGROUND

Passengers on vehicles, such as buses, trains and aeroplanes, often want to be able to access content while travelling and consume the content on their own personal communications devices. While some such devices may be configured to allow receipt of content over a mobile communications network from a remote content distribution system, network coverage often will not allow this, download bit rate will often be too low for the user to have a good experience, and charges by service providers may be high.

Vehicles may have their own on-board content distribution servers storing content. Passengers' devices may be configured to connect to such servers using Wi-Fi so that the passengers can download the content. Also, apparatus may be provided on such vehicles enabling such servers to establish connections with base stations of a telecommunications network. Such connections enable personal communications devices connected to the servers to download content stored by the remote content distribution system via the servers. Typically the remote content distribution system stores more content than the servers on board the vehicles, and/or the content stored by the remote content distribution system is more recent.

Typically, before content is downloaded, a device is sent information on available content and the passenger is able to select particular content to download. It is desirable for content offered to a particular passenger to be customised for that passenger, so that the passenger receives not just information on available content, but recommendations on content that might be of interest. Such information may be generated at the remote content distribution system.

However, when the remote content distribution system is unavailable due to absence of a connection between an on-board content distribution server and a telecommunications network, not all the content that has been recommended to the user may be available for the user to download. Plainly, this is a problem.

It is an object of the present invention to address these issues.

### SUMMARY OF THE INVENTION

In accordance with a first aspect of the present invention, there is provided a method comprising: determining, by a first server means local to a user device under the control of a user, if an internet connection is available enabling communication between the first server means and a second server means remote from the user device; based at least on a result of the determining being that the internet connection is unavailable, determining, by the first server means, local content items from a plurality of locally stored content items relevant to the user using locally stored contextual information associated with the user; and performing at least one action based on a result of the determining of the local content items.

Using this method, only content that is available is determined. Accurate information on available content may be provided to the user device, and/or attempts to provide content to the user device will not lead to an error due to the content being unavailable.

There is also provided a computer program product configured to perform the method.

According to a second aspect of the present invention, there is provided apparatus comprising: a processing means; a memory means and computer program code stored on the memory means, wherein the processing means and memory means with the computer program code are together configured so that execution of the computer program code by the processing means causes: determining, by a first server means local to a user device under the control of a user, if an internet connection is available enabling communication between the first server means and a second server means remote from the user device; based at least on a result of the determining being that the internet connection is unavailable, determining, by the first server means, local content items from a plurality of locally stored content items relevant to the user using locally stored contextual information associated with the user; performing at least one action based on a result of the determining.

### BRIEF DESCRIPTION OF THE FIGURES

For better understanding of the present invention, embodiments will now be described, by way of example only, with reference to the accompanying Figures in which:

FIG. 1 shows diagrammatically elements of the content distribution system, including a local server unit;

FIG. 2 shows illustratively offline content provision software for use at a local server;

FIG. 3 shows illustratively online content provision software for use at a remote server;

FIG. 4 is a flow diagram indicating steps in the process of delivering content to a user device when the local server unit is offline;

FIG. 5 is a flow chart indicating steps in determining content relevant to a user using contextual information; and

FIG. 6 is a flowchart indicating step by which a offline user profile store is updated.

### DETAILED DESCRIPTION OF EMBODIMENTS

Like reference numerals are used to denote like steps and elements throughout.

Embodiments of the invention to be described relate to determining content items that might be of interest to a user and to delivery of one or more of the content items, or to delivery of information, such as a menu, indicative of at least some of the determined items, to a user's personal communications device when the user is a passenger in a vehicle and when a connection to the internet is unavailable. The vehicle may be a bus, train, aeroplane or boat, for example. Embodiments of the invention have application wherever an internet connection is intermittently unavailable, and so embodiments are not limited to use in vehicles.

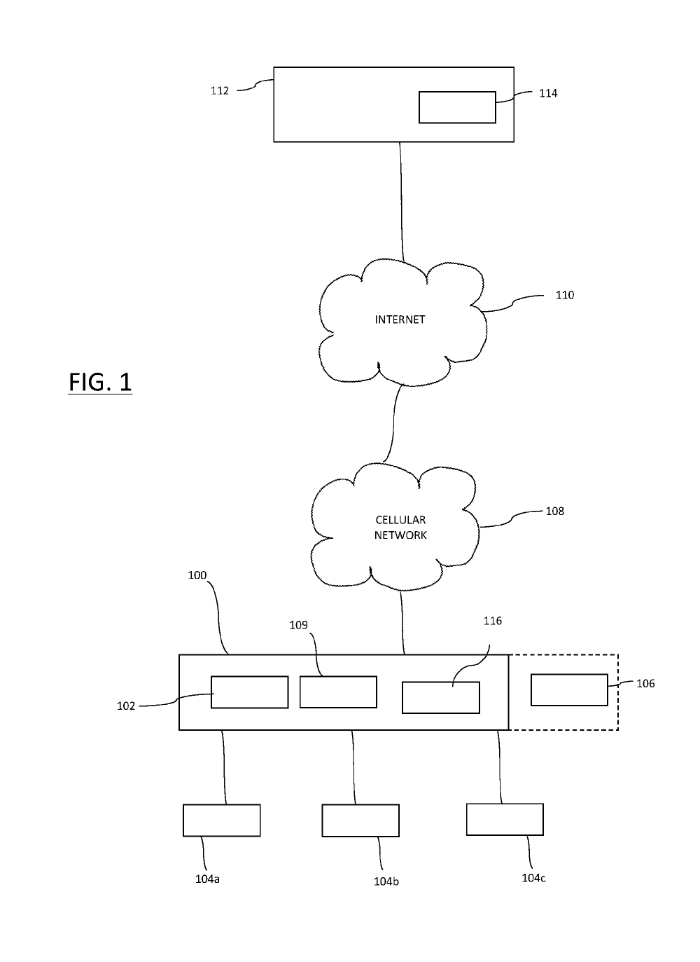

Referring to FIG. 1, a content distribution system is located partly in a vehicle (not shown) in which passengers may be carried. The parts in the vehicle comprises a local server unit 100, and a wireless access point 102 and a cellular communications gateway 106 both connected to the server unit 100.

A plurality of personal, portable communications devices are located in the vehicle, of which three are indicated at 104a-c. There would typically be greater than three such devices.

The access point 102 enables communication between the server unit 100 and the plurality of communications devices 104a-c, which are owned by the passengers. The communication between the server unit 100 and the communications devices 104a-c takes place over Wi-Fi. In variants embodiments, the server unit 100 and the personal communications devices 104 may be configured to communicate using alternative or additional suitable wireless communications technologies.

The communications devices 104a-c carried by the passengers are typically smart phones, tablet computers, such as iPads, or laptop computers. The communications devices are not limited to such; other devices may be suitably configured for communication with the server unit 100 and for consumption of content. For example, a communication device may be in the form of a wristwatch. The communications devices 104a-c each include a display and a user interface allowing operation of the device, amongst other components.

The cellular communications gateway 106 enables communication with base stations of a cellular wireless mobile telecommunications system 108 when the cellular communications gateway 106 is within the coverage area of the telecommunications system, that is, within communications range of at least one of the base stations. The telecommunications system 108 is connected to the internet 110. The gateway 106 may be part of the server 100, or external but connected to it, indicated by a dashed line in FIG. 1.

A remote system server 112 is also connected to the internet. Thus, when the vehicle is within range of the telecommunications network 108, the internet 110 and the telecommunications network 108 enable communication between the server unit 100 and the remote system server 112 via the cellular communications gateway 106.

In variant embodiments, the server unit 100 may be configured to establish a connection with the remote system server 112 other than by using the telecommunications network 108. For example, where there is a local area network to which the server unit 100 can connect using Wi-Fi, the server unit 100 may be configured to automatically connect to and send and receive data to and from the remote server 112 via the local area network like with the telecommunications network 108. Such local area networks may be present, for example where the vehicle is a bus at bus stations or service stations, or where the vehicle is a train at railway stations. The server unit 100 may additionally or alternatively be configured to connect to one or more suitable configured satellites in order to access the internet.

The remote server 112 is configured with online contextual content provision software, indicated at 114. This software 114 provides the remote system server 112 with some of the functionality ascribed to it herein. The term “online” is used herein to refer to when an internet connection is available between the server unit 100 and the remote system server 112, and in relation to the software 114 at the remote system server 112.

The server unit 100 is configured with offline contextual content provision software, indicated at 116. The online and offline contextual content provision software 114, 116 will be described in greater detail. The term “offline” is used herein to refer to when an internet connection is unavailable between the server unit 100 and the remote system server 112, and in relation to software at the server unit 110.

“Content” and “content items” as referred to herein may be but are not limited to: videos including films, television programs, documentaries, short-films, news and advertisements; software such as games; audio including podcast, news and advertisements; images including advertisements. Content items may be provided to the devices 104a-c by downloading or streaming. In some embodiments, content items, particularly advertising content items, may be sent to the devices 104a-c in a push manner. In some embodiments, the content items may be video content provided to the user in a channel, preferably with advertisements in the form of videos or banners, for example.

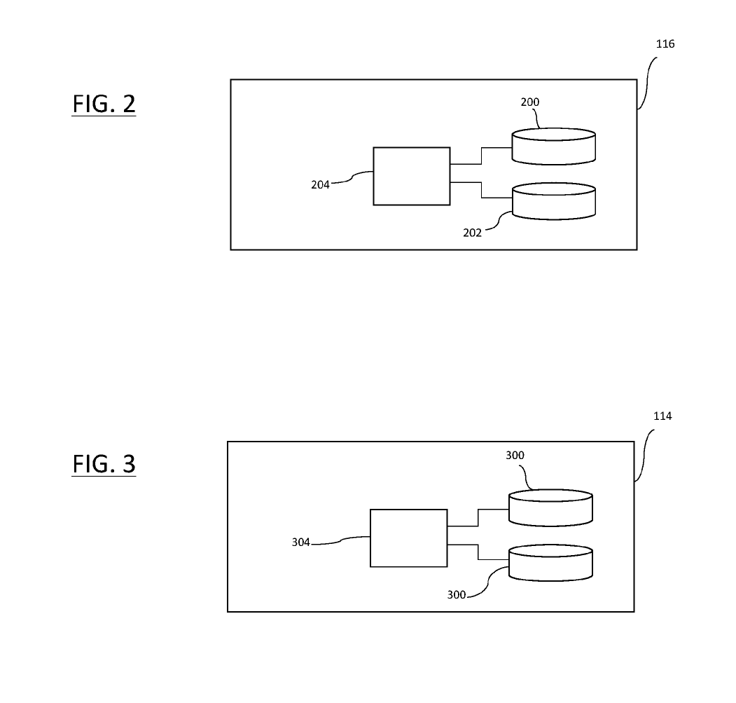

Referring to FIG. 2, the offline contextual content provision software 116 comprises an offline content store 200, an offline user profile store 202 and an offline application 204. The offline contextual content provision software 116 is generally configured to enable content provision to the devices 104. The offline application 204 is configured to determine content that may be of interest to individual users using user data in the offline user profile store 202 and other contextual data, and dependent on available content stored in the offline content store 200.

The contextual data used online and offline to determine content that may be of interest to a user preferably comprises both static and dynamic data. The static data is user-specific data such as age, likes and gender. Dynamic data is not-user-specific, for example location.

Information indicative of determined content is herein referred to as “offline content information”. The offline application 204 is also configured to handle updating of the offline content store 200 and the offline user profile store 202.

Referring to FIG. 3, the online contextual content provision software 114 comprises an online content store 300, an online user profile store 302 and an online application 304. The online contextual content provision software 114 is generally configured to provide content to the devices 104 when the server unit 100 is connected to the telecommunications network. The online application 304 is configured to determine content that may be of interest to each user using user data in the online user profile store 302 and other contextual data, and dependent on the content stored in the online content store 300. Information indicative of determined content is referred to herein as “online content information”. The online application 304 is also configured to handle updating of the online content store 300 and the online user profile store 302.

When information on available content is to be supplied to the device 104a, if the server unit 100 is connected to the remote system 112, the server unit 100 is configured to request the online content information for the user of the user device 104 from the remote system 112 and, on receipt, to send it to the device 104a. When the server unit 100 is not connected to the remote system 112, the server unit 100 is configured to determine the offline content information for particular users and to send the offline content information to the device 104a-c.

The offline content store 200 and the online content store 300 each store a plurality of content items. Some of the content items stored in the offline content store 200 may be the same as the content items stored in the online content store 300. Typically the online content store 300 stores more content items than the offline content store 200, for example a greater selection of videos or news articles may be available. Also, some of the content items stored by the online content store 300 may be more recent than the content items stored by the offline content store 200, for example the online content store 300 may have more up-to-date news articles.

The offline application 204 may be configured to interface periodically, when the server unit 100 is online, with the online application 304 to compare some or all content items in the offline content store 200 with content items in the online content store 300, and to periodically make changes to the content items in the offline content store 200. For example, if the offline content store 200 determines that a news article on the particular subject that is stored by the offline content store 200 is older than a news article on a particular subject stored by the online content store 300, the offline application 200 may download and store the more recent news article and delete the older one.

The offline user profile store 202 and the online user profile store 302 each includes a table associating for each user a user identifier with static and dynamic profile data. The static data comprises a market segment identifier, for example “young cosmopolitan”, “suburban middle-aged”, “married stay-at-home mothers”, “older affluent”. Preferably but not essentially the market segment identifier is determined based on behaviour of the user and is not based at all or exclusively on age. The market segment identifier is preferably generated wholly or in part from data collected on webpages visited, which is also stored in the respective store 202, 302. This is done by assigning one category of a plurality of possible categories to each webpage, for example, fashion or politics and determining the market segment identifier based on the particular categories of webpage visited by the user. The static data may also include information on the user, such as gender.

The dynamic profile data provide a plurality of dynamic data values, which may include, but is not limited to: time of day, usage that day, location of the user device. The location of the user device may be provided by the user device, or be determined by the server unit 100. Since the user device and the server unit 100 are local to one another, the location may be considered the same.

Each item of content includes metadata. The metadata includes at least one tag from many possible tags. Each market segment identifier is mapped to at least one tag. The aim of the mapping is that content items can be identified for a user based on the market segment identifier identified for them. The metadata may also include at least one tag corresponding to a dynamic data value. For example, the tag may specify a location or region, which may match to the dynamic data value.

When the server unit 100 is connected to the telecommunications network 108, user profile data in the on-line and off-line user profile data stores 302, 202 are preferably synchronised. The offline user profile data store 202 may be more up to date than the online user profile store 302 if the server unit 100 has been offline and a synchronisation is due.

The offline application 204 and the online application 304 are each configured to determine which content items stored in, respectively, the offline content store 202 and the online content store 304 relevant to the user. Each serves as a content recommendation engine. The content items may include advertisements. The offline content store 202 and the online content store 304 are also therefore advertisement determination engines.

The wireless access point 102 is configured to broadcast an SSID (service set identification). The local area network is open, such that any communications device 104a-c can connect to it without a password. The intention is for the passenger to be able to access content items in the content distribution system easily. When the passenger carries the device 104a within range of the wireless access point 102, if the passenger has not used the device 104a with the local area network before, the passenger may first have to perform an action to cause the device 104a to connect to the local area network. Otherwise, the device 104a may connect to the local area network automatically without any action being required by the passenger. Preferably the SSID broadcast on each vehicle of a network of vehicles is the same, so that a user device automatically connected to the local area network of each vehicle.

Next, if the passenger has not used the device 104 with the content delivery system before, the passenger operates the device 104 to open a web browser and the server unit 100 causes the device 104 to display a captive portal web page, which is displayed by the web browser. The user then operates the device 104 to register with the content distribution system, for example by submitting an email address using the captive portal. If the server unit 100 is online, the system server 112 creates a user profile for the passenger including a user identifier in the online user profile store 202 and this user profile is copied to the offline user profile store 304. In variant embodiments, this may be done the other way round. Methods of synchronisation are known to the skilled person and are not described in detail herein.

The server unit 100 then sends to the device 104a authentication information in the form of a cookie, and the authentication information is stored at the user device, the server unit 100 and the system server 112. This means that the server unit 100 and the system server 112 can recognise the device 104 and the user is not required to take any authentication action when subsequently using the content distribution system.

Additionally or alternatively to using the web browser, an application may be installed on the user device 104a which, when run on the device 104a, enables communication with the server unit 100.

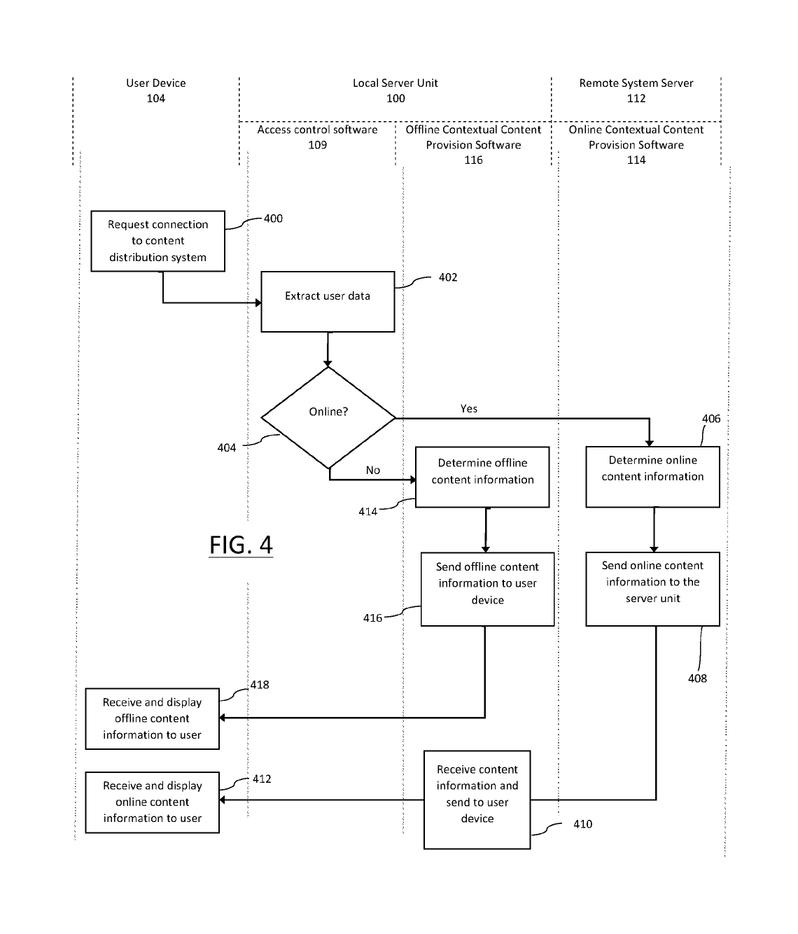

Operation of the content distribution system will now be described with reference to FIG. 4. At step 400, a user device 104a that has been authenticated is operated to send a request to the server unit 100, the request being for content information. The request may be in the form of an HTTP request including an URL, arising from the user selecting a link. The request preferably includes an identifier of the user, for example from the authentication information such as a cookie on the user device 104a.

Request for content information typically relates to information on available content. At step 402, the server unit 100 receives the request from the user device 104a and extracts user data including the identifier of the user. Based on received user data, the server unit 100 identifies the user using the user profile data.

At step 404, the server unit 100 determines if the server unit 100 is online or offline. In other words, the server unit 100 determines if content items stored at the remote system server 112 are reachable. The server unit 100 is online if the server unit 100 is within communications range of the telecommunications network 108.

If the server unit 100 determines at step 404 that the server unit 100 is online, then the server unit 100 sends a request to the remote system server 112 for information on content. The remote system server 112 then uses contextual data associated with the user to identify content items from the plurality of content items stored in the online content store 302 to determine at step 406 the online content information for the user. The remote system server 112 responds with the online content information at step 408, which is received by the server unit 100 at step 410. The server unit 100 then sends the actual content information to the user device 104a, which receives it at step 412. The user device 104a then displays the content information in a webpage, for example as a menu.

If the server unit 100 determines at step 404 that the server unit is offline, the server unit 100 uses locally stored contextual data associated with the user to determine, at step 414, content from the plurality of content items stored locally in the offline content store 202. The server unit 100 then sends at step 416 content information to the user device 104a, which receives it at step 418. The user device 104a then displays the offline content information in a webpage.

Following either step 412 or step 418, the web browser uses the received content information to display a list of content items that the user may then operate the user device 104a to download or stream. The list may include titles, images and description of the content. The content information may also include content in the form of one or more advertisements that are displayed to the user.

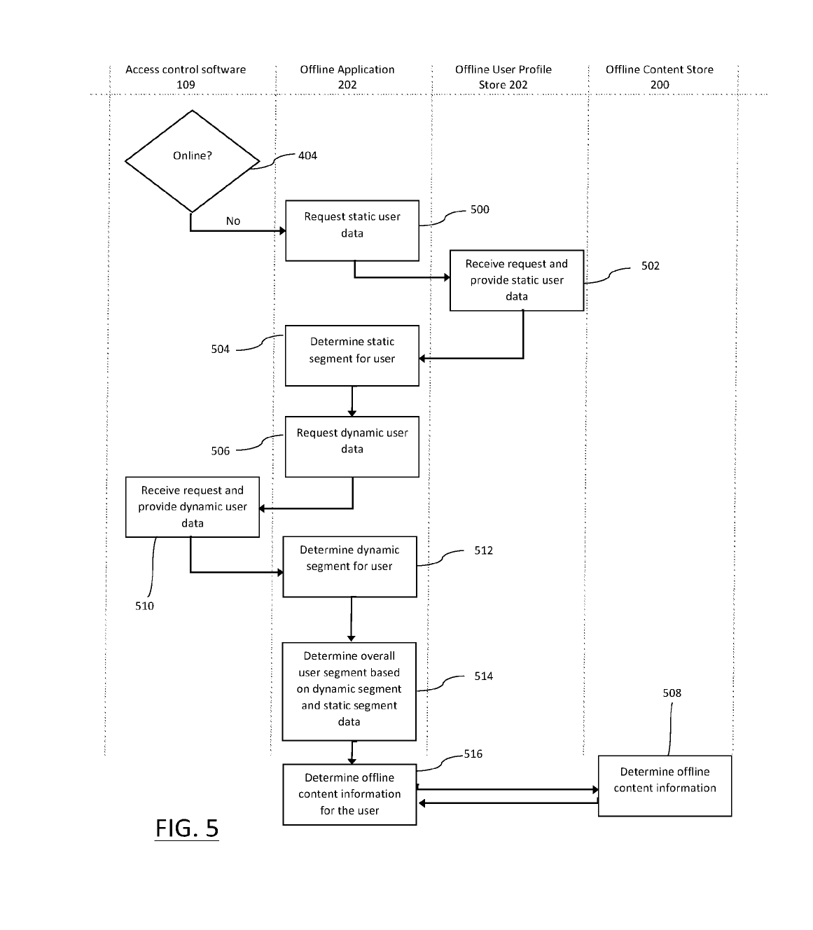

The process of determining offline content information, using contextual data, is now described in greater detail with reference to FIG. 5.

Initially, the control software 109 determines using the cellular communications gateway 106 at step 404 that the server unit 100 is off-line. The off-line application 204 then determines the user identifier at step 500 from the content request, and sends a request for static user profile data corresponding to the user identifier to the off-line user profile store 202. The off-line user profile store 202 replies with the static user profile data for the user at step 502.

At step 504, the off-line application 204 determines the static market segment identifier, from the plurality of possible static market segment identifiers, to which the user belongs using the static user profile data for the user.

The off-line application 204, then sends a request for dynamic user data, which is received by the control software 109 at step 506. The control software 109 replies with the dynamic user data at step 508. The off-line application 202 then determines the dynamic segment, from the plurality of possible dynamic segments, to which the user belongs using the dynamic user profile data for the user at step 510. For example, the dynamic segment may indicate that the user is in a particular city and the time is evening, for example.

The off-line application 204, then determines, at step 512, an overall user segment based on the static segment and the dynamic segment. For example, the overall user segment may be “young cosmopolitan in central Edinburgh on a evening out”.

The off-line application 204 then determines at step 514 offline content information for the user, that is, content items from those content items that are stored in the off-line content store 200 that are relevant to the user. The offline content information is then sent to the user device 104a for display to the user. The user may then operate the user device 104a to select a particular content item from content items identified in the offline content information, which initiates download by or streaming to the user device 104a from the offline content store 200 under the control of the offline application 202.

In a variant embodiment in which the content items includes advertising content items, the offline content information includes information regarding advertising content items and non-advertising content items. The non-advertising content information is then sent to the user device 104a together with one or more advertising content items, for display to the user. The user may then operate the user device 104a to select a particular non-advertising content item from content items identified in the offline content information. The one or more advertising content item may also be selectable, for example to initiate a process of purchasing a product or service.

In a variant embodiment, instead of the offline content information being sent to the user device 104a, content items may be sent. In particular, where the content items includes video content items, a channel comprising a plurality of concatenated video content items may be streamed to the user device 104a. The video items may include advertising content items and non-advertising content items.

It is mentioned above that the offline content information is determined based on the static segment and the dynamic segment. In addition, the offline content information may be determined based on other criteria. For example, content items tagged as news may only be included if they are timestamped within a certain prior period, for example two days.

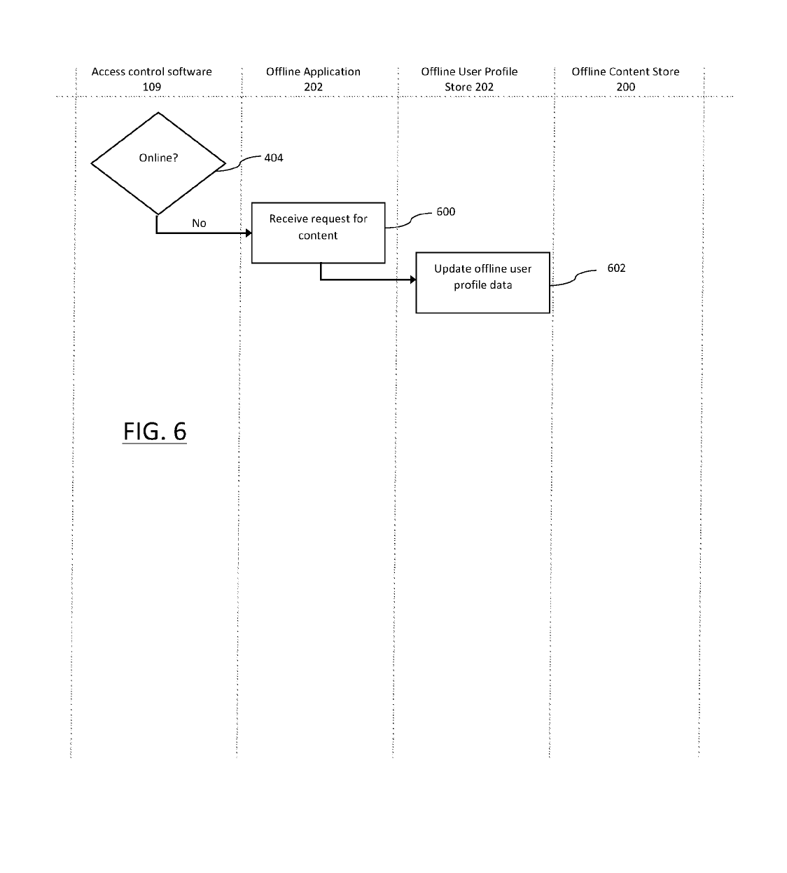

With reference to FIG. 6, a process of updating the static user data in the offline user data store is provided. When a content request is received at the control software 109 from the user, the control software 109 determines that the server unit 100 is offline at step 500. The offline application 204 also copies a URL in the content request and saves a copy in the offline user data profile 202 in association with the user identifier at step 600. The offline application 204 identifies one or more of the categories associated with the URL, and saves them in association with the user identifier. The one or more static market segments associated with the user is determined periodically based on the number of times a particular category has been identified.

The process of delivering content to the user device 104a when the local server unit is online is not described in detail; it may largely replicate the process described above, save online content information is determined at the system server 112 using the online content store 200, the online user profile store 202 and the online application 200 in place of the server unit 100 using the offline content store 300, the offline user profile store 302 and the offline application 300.

As will be appreciated by the person skilled in the art, the various hardware components referred to herein are themselves made of many components. For example, the server unit 100 typically includes a volatile memory and non-volatile memory, a processor, and appropriate interfaces for connecting to the wireless access point 102 and the cellular communications gateway 106, all operatively connected over a system bus. Each device 104a-c also includes a memory, a processor, and also transmitting and receiving means enabling wireless communication with the access point 102, for example. The processor in each user device and in the server 100 may comprises a plurality of connected processors.

It will be appreciated by persons skilled in the art that various modifications are possible to the embodiments.

The applicant hereby discloses in isolation each individual feature or step described herein and any combination of two or more such features, to the extent that such features or steps or combinations of features and/or steps are capable of being carried out based on the present specification as a whole in the light of the common general knowledge of a person skilled in the art, irrespective of whether such features or steps or combinations of features and/or steps solve any problems disclosed herein, and without limitation to the scope of the claims. The applicant indicates that aspects of the present invention may consist of any such individual feature or step or combination of features and/or steps. In view of the foregoing description it will be evident to a person skilled in the art that various modifications may be made within the scope of the invention.

1. A method comprising:
when an internet connection between a first server, which is local to a user device under the control of a user, and a second server remote from the user device is unavailable, receiving requests at the first server from the user device for webpages, identifying at the first server predetermined categories of the webpages and saving the identified categories in association with an identifier of the user;
updating user profile data for the user based on the saved categories;
when the internet connection is unavailable, determining, by the first server, local content items from a plurality of locally stored content items relevant to the user using locally stored contextual information associated with the user, the contextual information comprising the updated user profile data;
performing at least one action based on a result of the determining.

2. The method of claim 1, further comprising:
when the internet connection is available, sending to the second server a request for information indicative of remotely stored content relevant to the user, and an identifier of the user;
receiving, by the first server, from the second server content information and/or content items for the user determined at the second server using further contextual information associated with the user;
sending the content information and/or content user device.

3. The method of claim 1, wherein the performing at least one action comprises sending information indicative of at least some of the determined local content items to the user device.

4. The method of claim 1, wherein the performing at least one action comprises pushing at least some of the determined local content items to the user device.

5. The method of claim 1, wherein the first server and the user device are located on a vehicle.

6. The method of claim 1, wherein the first server and the user device are connected over a local area network.

7. The method of claim 1, wherein the determining if an internet connection is available comprises determining whether the first server is within communications range of a cellular communications network.

8. The method of claim 1, further comprising determining the contextual information associated with the user at the first server.

9. The method of claim 8, wherein the contextual information further comprises dynamic user data stored at the first server.

10. The method of claim 9, wherein the dynamic user data comprises at least one of: time of day, usage that day, location of the user device, local weather.

11. (canceled)

12. The method of claim 11, wherein the user profile data includes identifiers of one or more market segments assigned to the user based at least on webpages visited the identified categories.

13. (canceled)

14. The method of claim 1, wherein the determining if an internet connection is available enabling communication between the first server and a second server is performed in response to receiving a request from the user device for information on available content or for content.

15. A computer program product comprising computer program code, stored in a computer readable storage medium, which, when executed by a processing means, causes the processing means to:
determine when an internet connection is unavailable with a remote server;
when the internet connection is unavailable, identify predetermined categories of webpages requested in requests received from a local user device and save the identified categories in association with an identifier of the user;
update user profile data for the user based on the saved categories;
when the internet connection is unavailable, determine local content items from a plurality of locally stored content items relevant to the user using locally stored contextual information associated with the user, the contextual information comprising the updated user profile data:
performing at least one action based on the determined local content items.

16. Apparatus comprising:
a processing means;
a memory means and computer program code stored on the memory means, wherein the processing means and memory means with the computer program code are together configured so that execution of the computer program code by the processing means causes:
determining at a server local to a user device under the control of a user, if an internet connection is available enabling communication with a remote server;
when the internet connection is unavailable, receiving requests from the user device and identifying predetermined categories for the requested webpages;
updating at the server user profile data for the user based on the saved categories;
when the internet connection is unavailable, determining at the server local content items from a plurality of locally stored content items relevant to the user using locally stored contextual information associated with the user, wherein the contextual information comprises the updated user profile data for the user;
performing at least one action based on the determined local content items.

17. The apparatus of claim 16, further comprising a cellular communication network gateway, wherein the determining if an Internet connection is available enabling communication with a remote server means remote uses the gateway.

18. The apparatus of claim 16, further comprising an access point enabling Wi-Fi.

19. (canceled)

20. The method of claim 1, further comprising, after the updating of the user profile data at the first server, when the first server is connected to the internet, synchronising user profile data for the user in a user profile data store at the second server with user profile data for the user in a user profile data store at the first server.
